(19) United States
(12) Patent Application Publication
(10) Pub. No.: US 2012/0273583 A1
(43) Pub. Date: Nov. 1, 2012

(54) LIQUID SUPPLY ASSEMBLY WITH AN IMPROVED LINER

(75) Inventors: Ronald L. Gerson, Carlisle, MA (US); James P. Flannery, JR., Scituate, MA (US)

(73) Assignees: SAINT-GOBAIN ABRASIFS, Conflans-Sainte-Honorine (FR); SAINT-GOBAIN ABRASIVES, INC., Worcester, MA (US)

(21) Appl. No.: 13/298,273

(22) Filed: Nov. 16, 2011

Related U.S. Application Data
(60) Provisional application No. 61/414,217, filed on Nov. 16, 2010.

(51) Int. Cl. B65D 21/02; B65D 35/56; B05B 15/00

(52) U.S. Cl. 239/1; 220/23.87; 239/302; 222/105

(57) ABSTRACT

An improved liner is provided for use with a liquid container system for a spray gun. The liquid container system includes a cup, a ring disposed on a lip of the cup, the liner which is supported within the cup by the ring, and a lid which closes the open end of the liner and connects to the spray gun. The liner includes an open end, a closed end opposed to the open end, and one or more longitudinally-extending stiffening ribs that extend across an apex of the liner closed end.

### BACKGROUND

Spray guns can be used for rapidly coating surfaces with liquids, such as paint. Paint can be contained in a container that attaches to the spray gun. The outlet of the container can be a releasably connectable coupling that connects to the spray gun. Paint can flow from the container into the spray gun and then, fed to a spray nozzle. The spray nozzle can combine the paint with air, atomize the liquid, and form a spray. At the end of the spraying operation, the container and the mating connection to the spray gun should be thoroughly cleaned so that the paint from one operation does not contaminate the paint to be sprayed in the next spraying operation. Additionally, the coupling between container and spray gun should be free of any dried liquid that might interfere with the connection between container and spray gun. A container with a disposable liner and lid may be used advantageously to eliminate or reduce the labor required to clean the container and the coupling to the spray gun.

### BRIEF DESCRIPTION OF THE DRAWINGS

The foregoing features will be more readily understood by reference to the following detailed description, taken with reference to the accompanying drawings, in which:

FIG. 1 includes an exploded perspective view of a liquid container system in accordance with an embodiment;

FIG. 2 includes an exploded perspective view of a connector system in accordance with an embodiment;

FIG. 3 includes a perspective view of a connector system in accordance with an embodiment;

FIG. 4 includes a first cross-sectional view of a connector system in accordance with an embodiment;

FIG. 5 includes a second cross-sectional view of a connector system in accordance with an embodiment;

FIG. 6A includes a perspective view of a container liner in accordance with an embodiment;

FIG. 6B includes a side plan view of a container liner in accordance with an embodiment;

FIG. 6C includes a detailed view of a liner in accordance with an embodiment taken at location E of FIG. 6B;

FIG. 7 includes a cross-sectional view of a liquid container system in accordance with an embodiment;

FIG. 8A includes a perspective view of an outer cup in accordance with an embodiment;

FIG. 8B includes a top plan view of an outer cup in accordance with an embodiment;

FIG. 8C includes a side plan view of an outer cup in accordance with an embodiment;

FIG. 9A includes a perspective view of a unitizing ring in accordance with an embodiment;

FIG. 9B includes a top plan view of a unitizing ring in accordance with an embodiment;

FIG. 9C includes a side plan view of a unitizing ring in accordance with an embodiment;

FIG. 10A includes a cross-sectional view of a liquid container system in accordance with an embodiment;

FIG. 10B includes a detailed view of a liquid container system in accordance with an embodiment taken at location K in FIG. 10A;

FIG. 11A includes an exploded perspective view of a liquid container system in accordance with an embodiment;

FIG. 11B includes a perspective view of a liquid container system in accordance with an embodiment;

FIG. 12 includes a perspective view of a lid in accordance with an embodiment;

FIG. 13 includes a perspective view of a liquid container system in accordance with an embodiment;

FIG. 14 includes a cross-sectional view of a liquid container system take through the upper portion of FIG. 13;

FIG. 15 includes a perspective view of a lid in accordance with an embodiment;

FIG. 16 includes a side plan view of a lid in accordance with an embodiment;

FIG. 17 includes a perspective view of a liner in accordance with an embodiment;

FIG. 18 includes a side view of a liner in accordance with an embodiment;

FIG. 19 includes a detailed view of a liner in accordance with an embodiment take at location B in FIG. 18;

FIG. 20 includes a perspective view of a liner in accordance with another embodiment;

FIG. 21 includes a side plan view of a liner in accordance with another embodiment;

FIG. 22 includes a detailed view of a liner in accordance with another embodiment take at location C in FIG. 21;

FIG. 23 includes a perspective view of a liner in accordance with yet another embodiment;

FIG. 24 includes a side plan view of a liner in accordance with yet another embodiment;

FIG. 25 includes a detailed view of a liner in accordance with yet another embodiment take at location D in FIG. 24;

FIG. 26 includes a perspective view of a liner in accordance with still another embodiment;

FIG. 27 includes a side plan view of a liner in accordance with still another embodiment; and

FIG. 28 includes a detailed view of a liner in accordance with still another embodiment taken at location A in FIG. 27.

### DETAILED DESCRIPTION

In some aspects, a liner is provided for use with a liquid container system for a spray gun. The liquid container system can include a cup and a ring disposed on a lip of the cup. A liner can be supported within the cup by the ring. The system can also include a lid which closes the open end of the liner and is connectable to the spray gun. In a particular aspect, the cup can include a closed end and an open top and the top can include a cup lip that can further include a cup lip recess. In another aspect, the ring can include a peripheral flange and a ring recess can be formed in the flange. Further, the peripheral flange can be inserted into the cup lip recess. Specifically, in a particular aspect, the peripheral flange can be sized and shaped to fit into the cup lip recess.

In a particular aspect, the liner can include a non-flat closed end and an open end formed with a liner lip. A mid portion can be disposed between the closed end and the open end. The open end of the liner is opposite the closed end of the liner, and the open end of the liner can be configured for the introduction of liquid into the liner. Moreover, the liner can be inserted through the ring into the cup, and the liner lip can be adapted for insertion into the ring recess. The liner lip can be sized and shaped to fit into the ring recess. In addition, the liner can include a longitudinally-extending stiffening rib that, in certain embodiments, can extend across an apex of the closed end of the liner.

In one or more embodiments, the rib can be V-shaped in cross section and the rib can protrude outwardly from an outer surface of the liner. Moreover, the rib can be formed by coining by a V-shaped liner portion. In another embodiment, the liner can further includes a cross stiffening rib that can extend across the apex of the closed end so as to orthogonally intersect the stiffening rib.

In a particular aspect, the liner can be formed of a flexible film. Further, the liner can be formed of a nonporous material. Specifically, the liner can be formed from one of polyethylene and polypropylene. Additionally, the liner side walls can be formed having a thickness greater than the thickness of liner bottom.

In some aspects a liner is provided for a liquid container system for a spray gun. The liner can include a non-flat closed end, an open end opposed to the closed end, and sidewalls that can surround a longitudinal axis that can extend between the closed and open end. The liner can be configured to collapse in a first direction transverse to the longitudinal axis and to not collapse in a second direction that is transverse to both the first direction and the longitudinal axis.

By way of example and not by way of limitation, the liner may be used with any of the liquid containers shown in co-pending U.S. patent application Ser. No. 11/302,970, entitled “Liquid Container System for a Spray Gun,” which is incorporated herein by reference.

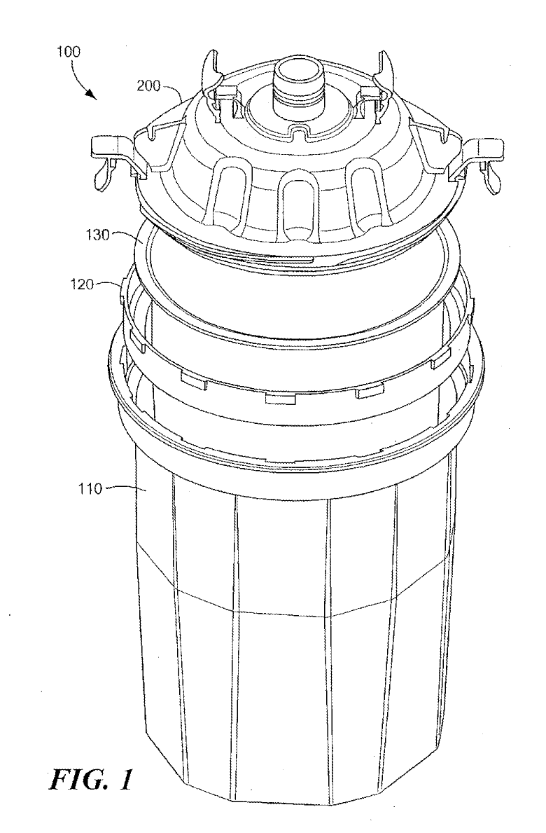

FIG. 1 illustrates an exploded view of a container system, designated 100, in which the liner can be installed. As depicted, the container system 100 can include an outer support cup 110, a unitizing ring 120, a liner 130 and a lid 200. As described in further detail herein, the unitizing ring 120 can be inserted into a recess in a flange at the top of the outer cup 110. The disposable, collapsible liner 130 can be inserted through the ring 120 into the outer cup 110 and a lip at the top of the liner 130 can be supported on the unitizing ring 120.

Further, the lid 200 can include a projection that can slide into an opening at a top of the liner 130. The lid 200 can screw into the unitizing ring 120 and a flange or a flexible sealing gasket on the periphery of the lid 200 can press the liner lip against the unitizing ring 120, forming a liquid tight seal.

In a particular embodiment, a unitizing ring 120 includes a ring 120 that in combination with other components (e.g., a liner 130 and lid 200) can allow the combination to be manipulated as a unit. Thus, the lid-ring-liner assembly may be removed from the outer cup 110 as a liquid-tight unit, while reducing a likelihood of the liquid-filled liner 130 separating from the lid 200. When the lid 200 is installed on the unitizing ring 120, the lid-ring-liner assembly can be secured to the outer cup 110 with a locking mechanism, described in detail herein.

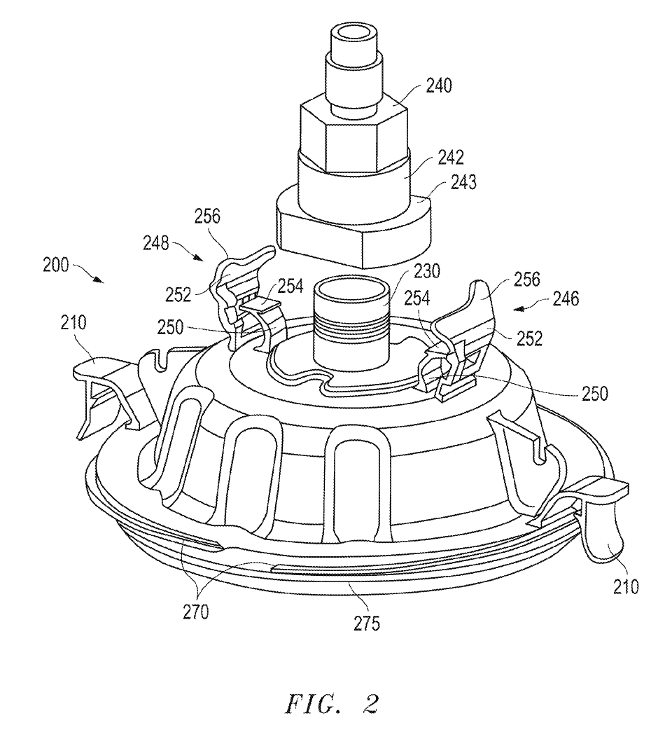

In a particular embodiment, as shown in FIG. 2, a connector system is provided and can include a lid 200 and an adapter 240. The lid 200 can cover the top of the liquid container system 100 (FIG. 1) that includes the outer cup 110 (FIG. 1). The lid 200 can be inserted into the outer cup 110 and attached to the outer cup 110 by, for example, locking clips or hinges 210 on the periphery of the lid 200. The lid 200 can include a generally cylindrical liquid outlet 230 extending from a top of the lid 200. One end of the adapter 240 can connect to a spray gun liquid inlet port (not shown) and the other end of the adapter 240 can connect to the liquid outlet 230 in the lid 200. In a particular aspect, the adapter ends can be joined by a liquid-tight passageway.

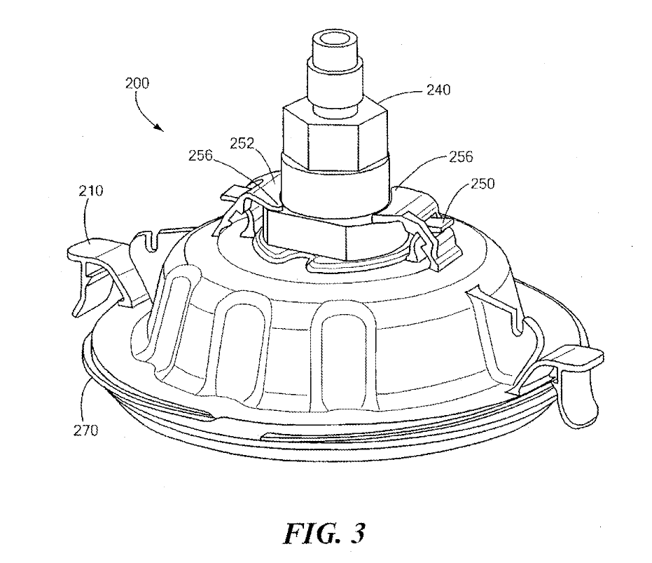

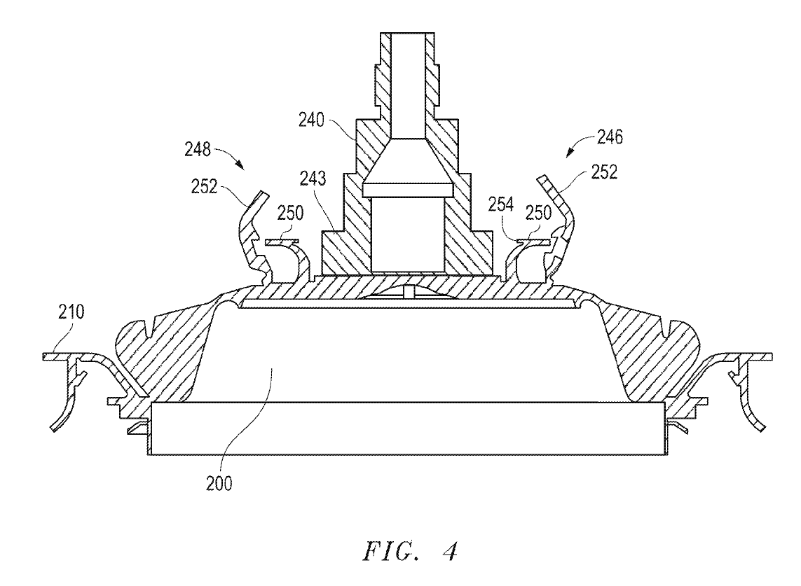

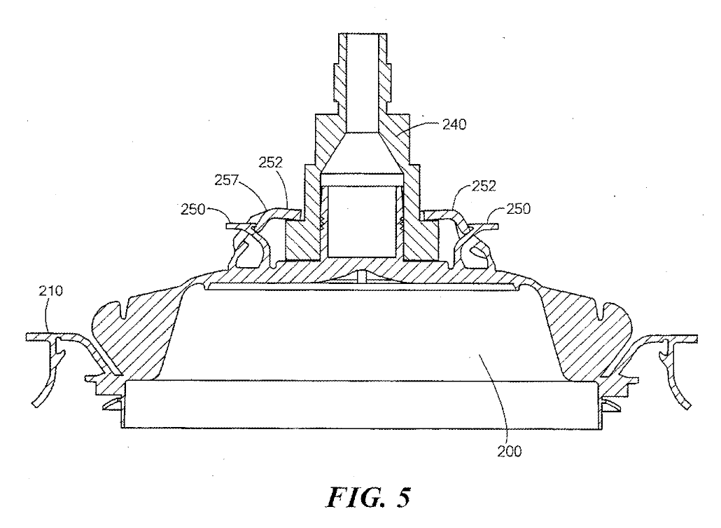

As indicated in FIG. 2, the lid 200 can include a first interlocking tab assembly 246 and a second interlocking tab assembly 248 that can be moved between a non-interlocking configuration and an interlocking configuration. As described in further detail below, when the tab assemblies 246, 248 are in the interlocked configuration, the end 256 of the clamping tab 252 can press on adapter ledge 243 and can clamp the adapter 240 to the liquid outlet 230 of the lid 240, as depicted in FIGS. 3 and 5. Thus, the adapter 240 can be relatively securely fastened to the lid 200, facilitating use of the spray gun and liquid container system 100 (FIG. 1) in various orientations.

The interlocking tab assemblies 246, 248 are illustrated in FIG. 2 in the non-interlocked configuration. In a particular embodiment, the interlocking tab assemblies are identical and each interlocking tab assembly can include a locking tab 250 and a clamping tab 252. The clamping tab 252 can engage the adapter 240. As indicated in FIG. 2, the clamping tab 252 can be biased open (i.e., away from the adapter 240) in the non-interlocking configuration.

In a particular aspect, the locking tab 250 of each interlocking tab assembly 246, 248 can lock the corresponding clamping tab 252 into position when the clamping tab 252 is engaged with the adapter 240. Further, each clamping tab 252 can include a hole for receiving an end of a respective locking tab 250. The hole in each clamping tab 252 and the corresponding end of each locking tab 250 can be shaped in a complementary fashion so that the end of each locking tab 250 can slide into and through the hole in each corresponding clamping tab 252. In a particular embodiment, the hole in each clamping tab 250 can be generally rectangular in shape. However, the hole in each clamping tab 250 can have any other polygonal shape.

During operation, in order to engage the tabs 250, 252, a user can push each clamping tab 252 towards the attached adapter 240, which threads each corresponding locking tab 250 into and though the hole in the clamping tab 252. Each locking tab 250 can flex slightly about the attachment point to the lid 200 in order to facilitate engagement of each locking tab 250 and with each respective clamping tab 252. The described user action can engage the tabs 250, 252 of each interlocking tab assembly 246, 248.

Moreover, an end of each clamping tab 256 can press on the adapter ledge 243 and effectively clamp the adapter 240 to the lid 200, as shown in FIG. 3. Further, the substantially minimal flex of each locking tab 250 can maintain the end 256 of each clamping tab 252 in secure engagement with the adapter 240, when the tabs 246, 248 are interlocked.

In a particular embodiment, each locking tab 250 can include a locking structure 254, such as the ridge 254 depicted in FIG. 2. The ridge 254 can prevent the engaged tabs 246, 248 from separating (i.e., moving from the interlocked configuration to the non-interlocked configuration) by engaging the locking structure 254 with an edge, e.g., an upper edge, of the hole formed in the corresponding clamping tab 252. The clamping tab 252 can be unlocked from the locking tab 250 by applying downward pressure to the locking tab 250, releasing the locking structure 254 from the hole. The clamping tab 252 will tend to spring away from the adapter 240 to an original position. The adapter 240 may then be removed from the liquid outlet 230.

FIG. 3 depicts the interlocking tab assemblies 246, 248 in the interlocked configuration. In the interlocked configuration, the end 256 of each clamping tab 252 can press on the adapter ledge 243 to clamp the adapter 240 to the lid outlet 230. In a particular aspect, the end 256 of each locking tab 252 can be curved in order to provide a relatively snug fit to the curved portion 242 of the adapter 240 that the locking tabs 252 contact, regardless of the position of the adaptor 240. In this embodiment, the adapter 240 can remain relatively securely engaged with the liquid outlet 230 for any orientation of the adapter 240 with respect to the liquid outlet 230, when the adapter 240 is rotated.

FIG. 4 and FIG. 5 illustrate a cross-sectional view of the connector system with the interlocking tab assemblies 246, 248 open and closed, respectively. As depicted in FIG. 5, each clamping tab 252 can include a bent portion 257 between the point where each clamping tab 252 attaches to the lid and where the end 256 of each clamping tab 252 contacts the adapter 240. In certain embodiments, the bent portion 257 in each clamping tab 252 is sufficiently acute so that each clamping tab 252 flexes at the bent portion 257 as the end 256 of each clamping tab 252 contacts the adapter ledge 243. The flexibility of each clamping tab 252 can aid in clamping the adapter 240 to the lid 200.

Although two interlocking tab assemblies 246, 248 are shown on the container lid 200 in FIG. 2 through FIG. 5, other embodiments of the connector system may have more than two interlocking tab assemblies 246, 248.

In a particular embodiment, the lid 200 and the interlocking tab assemblies 246, 248 can be injection molded as a single piece, using techniques known in the art. In a particular aspect, the lid 200 and tab assemblies 246, 248 are made of polypropylene. In other aspects, other materials that are suitable for injection molding can be used. Further, the lid 200 and interlocking tab assemblies 246, 248 can be shaped to facilitate release of the molded part from a mold.

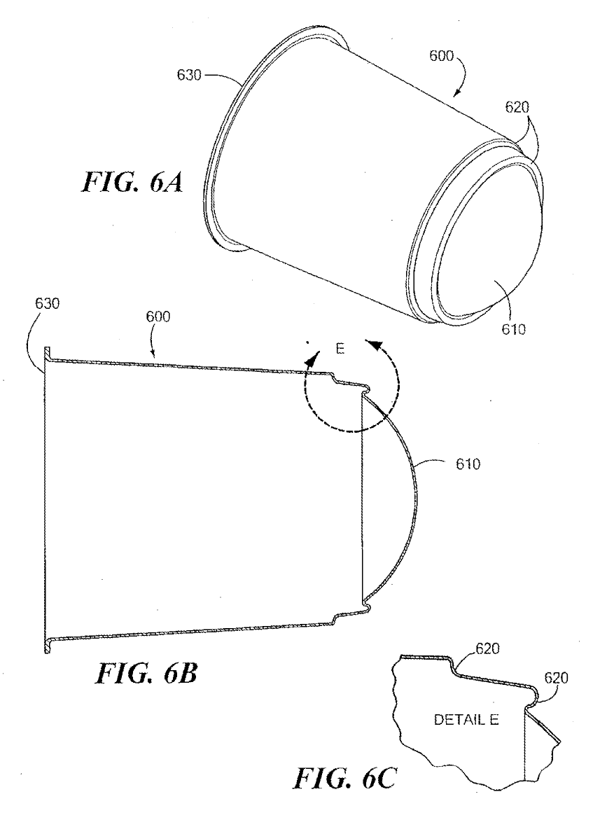

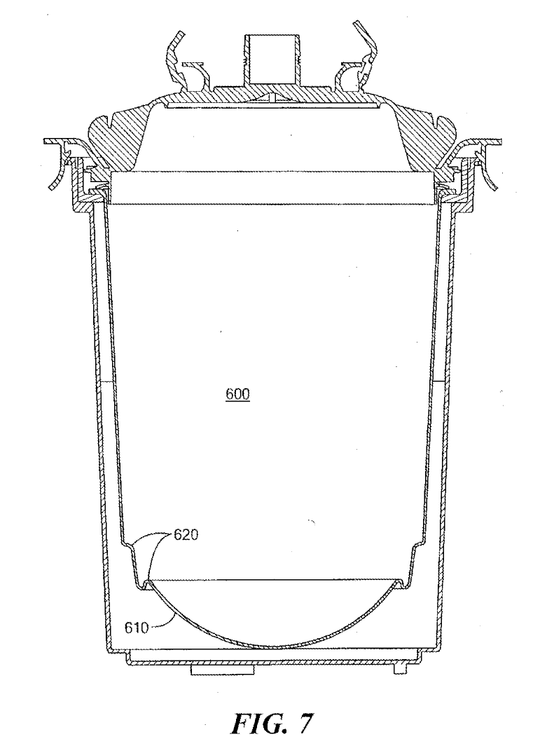

In another embodiment, as depicted in FIG. 6A through FIG. 6C, a disposable liner 600 is provided for use in a liquid container system, such as, for example the container system 100 depicted in FIG. 1. As illustrated, the liner 600 has a non-flat closed end 610, an open end 630 for introducing liquid into the liner 600 and one or more horizontal pleats 620 at the closed end 610. The liner 600 can be made from any nonporous material, including but not limited to, polyethylene, polypropylene or a flexible film. Further, the 600 liner may be rigid or collapsible. In a particular embodiment, the liner sidewalls may be thicker than the liner bottom, facilitating storage of liquid in the liner 600. FIG. 7 includes a cross-sectional view of the liner 600 installed in an exemplary liquid container system 100 (FIG. 1). The disposable liner 600 can facilitate cleaning of the container system 100 (FIG. 1) after use.

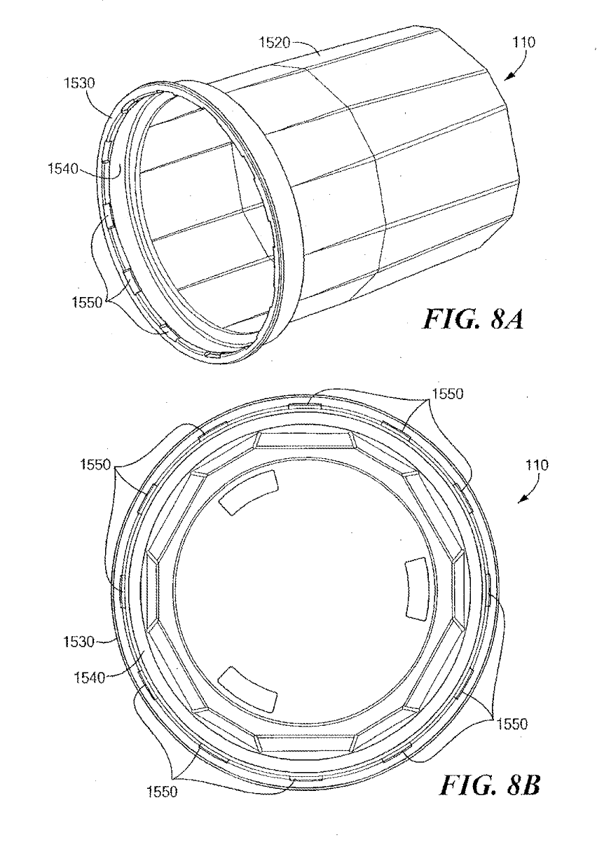

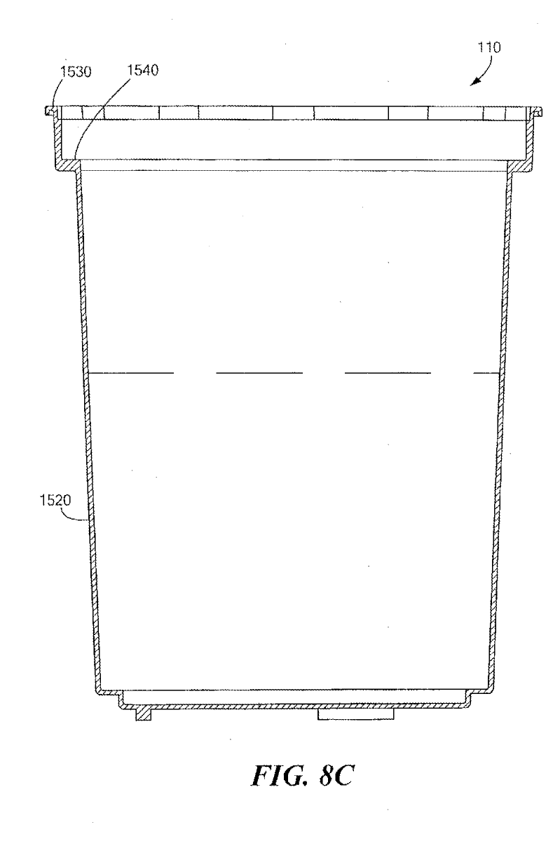

As described above, FIG. 1 includes an exploded view of a liquid container system 100 in which the connector system can be applied. FIG. 8A includes a perspective view of the outer cup 110. The cup 110 can be generally cylindrically shaped. The outer cup 110 can be made of a relatively stiff material, such as a polymeric material, which can provide structural stability.

In the embodiment depicted in FIG. 8A, the outer wall 1520 of the cup 110 can include facets to facilitate a secure grip of the outer cup 110 by the user. In general, however, the outer wall 1520 of the outer cup 110 can be implemented with any generally cylindrical shape. Moreover, the outside and inside bottom of the cup can be flat or other than flat.

In a particular aspect, the top of the outer cup 110 can include a generally cylindrical lip 1530 that can be concentric with the longitudinal axis of the outer cup. FIG. 8B includes a plan view of the cup lip 1530 as viewed from above. The lip 1530 can include an indentation or recess 1540. The recess 1540 can receive and support the unitizing ring-liner assembly, as described below. The cup lip 1530 can include slots 1550 in a face of the cup lip 1530 which is interior to the cup 110.

As described herein, tabs formed on, and extending from, the ring 120 may engage the slots 1550 formed in the cup lip 1530 to prevent mutual rotation of the ring 120 with respect to the cup 110. FIG. 8C illustrates the outer cup 110 in cross section. In a particular embodiment, the outer cup 110 can include one or more openings in the closed end of the cup 110 or the sidewall 1520 of the cup 110 in order to prevent vacuum formation and to allow paint to be expelled from the container system 100 (FIG. 1).

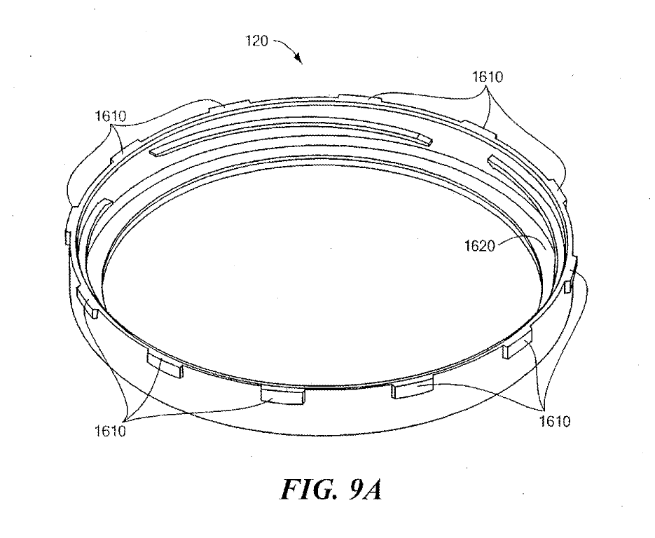

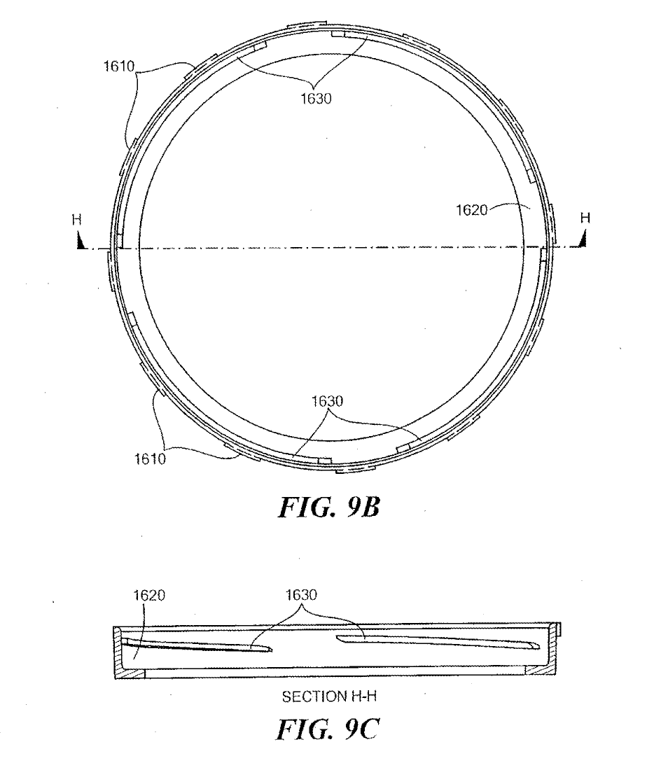

FIG. 9A through FIG. 9C illustrate a unitizing ring 120 according to an embodiment of the liquid container system 100 (FIG. 1). FIG. 9A depicts the ring 120 in a perspective view. The ring 120 can be generally annular in shape with the periphery of the annulus shaped to match the recess 1540 in the lip of the outer cup 110. The ring 120 can include tabs 1610 extending outward from the top of the ring 120 such that the tabs 1610 can mate with slots 1550 in the top of the outer cup to substantially prevent rotation of the ring 120 with respect to the cup 110.

The ring 120 can include a recess 1620 for receiving and supporting a lip at the open end of a liner, e.g., one of the liners disclosed herein, as will be described below. The ring recess 1620 can be annular in shape with a circular periphery, but, in general, the ring recess 1620 can assume any shape that corresponds to the shape of the lip of a liner. The inside of the unitizing ring 120 can include rib segments 1630 that extend inwardly from an inner wall of the ring 120. The rib segments 1630 can be generally parallel to the plane of the ring 120 and the rib segments 1630 can be pitched slightly downwardly toward the cup end of the ring 120 to act as screw threads for securing the lid 200 to the ring 120.

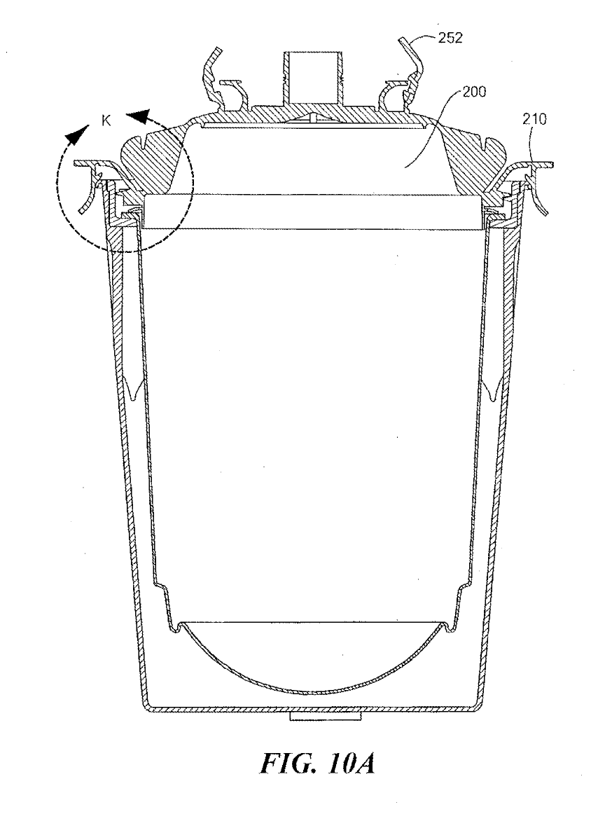

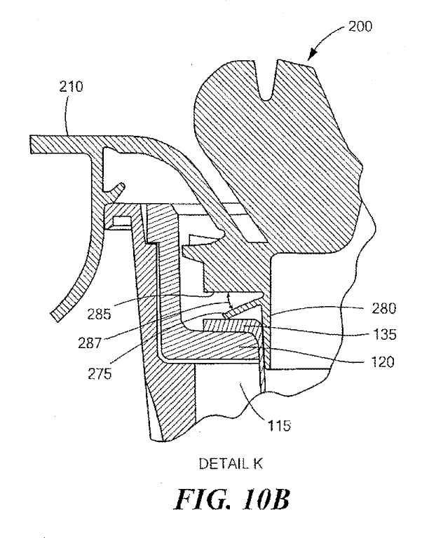

FIG. 1, described above, depicts the components that can be included in the liquid container system 100 (FIG. 1). The components are further illustrated in FIG. 8 through FIG. 10. The unitizing ring 120 can be inserted into the recess 1540 in the lip 1530 at the open end of the outer cup 110. A liner 130 can be inserted into the unitizing ring 120, with a lip 135 at the top of the liner 130 resting on a recess 1620 in the ring 120 (see FIG. 9A). A removable lid 200, as illustrated in FIG. 10, can include a bottom projection 280 that is inserted into the open end of the liner 130, after liquid has been poured into the liner 130. The lid 200 can be adapted to contain paint or other liquid within the liner 130 and to substantially prevent air from entering the closed lid/liner combination.

Such closure can occur when the spray gun is attached to the assembly 100 (FIG. 1) for use, or when the container outlet 230 is sealed with a removable cap or plug 1120. The removable cap or plug 1120 can be used to seal the filled assembly either in preparation for forthcoming use or to store unused paint for future use.

In a particular embodiment, as indicated in FIG. 10B, the underside of a flange 285 on the periphery of the lid 200 can force the lip 135 of the liner 130 into the recess 1620 in the unitizing ring 120, enabling a substantially liquid-tight seal. In a particular embodiment, the diameter of the lid bottom projection 280 and the inner diameter of the ring recess 1620 are such that the top of the sidewall of the liner 130 is compressed when the lid 200 is attached to the unitizing ring 120. Compression of the liner sidewall between lid bottom projection 280 and ring recess 1620 in this embodiment can aid in forming a substantially liquid tight seal.

In another aspect, the lid bottom projection 280 and the inner edge of the ring recess 1620 may both be tapered to aid in assembly of the liner 130, lid 200 and ring 120. Tabs or threads 270 at the edge of the lid 200 can allow the lid 200 to be screwed into rib segments or threads 1630 on the unitizing ring 120, substantially securing the lid 200 to the ring 120. One or more securing hinges 210 on the lid 200 can secure the lid 200 to the outer cup 110, allowing the liquid container system 100 (FIG. 1) to be oriented in any direction without detachment of the outer support cup 110 from the system 100. The securing hinges 210 can clip over a flange on the outer cup 110. The securing hinges 210 are flexibly hinged and can be biased to snap onto the flange of the outer cup 110.

In a particular aspect, the lid has an outlet 230 of generally cylindrical shape so that liquid may be transferred from outer cup 110 to the spray gun. The lid outlet, an adapter for connection to a spray gun that mates thereto and means for securing the adapter to the outlet may be constructed as described above in connection with FIG. 2 through FIG. 5. The securing hinges 210 for connecting the lid to the outer cup is by way of example only and a variety of such mechanisms, as are known in the art, may be used to secure the lid 200 to the cup 110, in various embodiments.

The liner 600 illustrated in FIG. 6A through FIG. 6C and described herein can be employed in embodiments of the liquid container system 100 (FIG. 1). A liner 600 for use in the system 100, in general, can be:
substantially liquid tight;
open-ended with a lip 135 surrounding the open end 630, so that the lip 135 may be supported by the recess 1620 in the unitizing ring 120 and the lip 135 may be pressed by the compressible flange 285 of the removable lid 200 against the ring recess 1620 (as illustrated in FIG. 10B).

In certain embodiment, the liquid container system 100 can be coupled with either a gravity feed spray gun or a suction feed spray gun, with the outlet 230 of the lid 200 connected to the inlet port of the gun by an adapter, such as the adapter 240 described herein. During operation, liquid, e.g., paint, can be withdrawn from the container system 100 and fed to a spray nozzle of the spray gun. The spray gun can be oriented in a wide range of orientations, including an inverted orientation with respect to gravity.

In a further embodiment, as illustrated in FIG. 10A and FIG. 10B, an integrated, compressible flexible sealing gasket 275 can be provided at a peripheral edge of the removable container lid 200 in the liquid container system. The sealing gasket 275 can form a substantially liquid tight seal between the lid 200, liner 130, and the ring 120. The liquid container system may be generally similar, for example, to the system described above in connection with FIGS. 1-5 and FIGS. 7-9.

FIG. 10A includes a cutaway side view of a container system 100, employing the flexible sealing gasket 275 on the lid 200. As illustrated, the sealing gasket 275 can include a downward flaring circumferential projection that can extend from the underside of the lid flange 285 on the periphery of the lid 285 at, or near, a top of the lid bottom projection 280.

FIG. 10B illustrates the detail of the lid-liner-unitizing ring attachment, labeled “K” in FIG. 10A. The lid 200 can screw into the unitizing ring 120, as described herein, and the flexible sealing gasket 275 can press the liner lip 135 against the unitizing ring 120 to form a substantially liquid tight seal. The lid projection 280 may press the liner sidewall against the inner surface 115 of the outer wall 1520 of the support cup 110. In another aspect, the dimensions of the lid projection 280 may provide clearance between the lid projection 280 and the liner sidewall in order to facilitate easy insertion of the lid projection 280 into the open end 630 of the liner 130 and the top of the support cup 110.

In a particular aspect, the flexible sealing gasket 275 can be formed by injection molding, for example, as the lid 200 is manufactured, avoiding the cost of a separate extra gasket and the complexity of an additional part. In a particular embodiment, the thickness of the flexible sealing gasket 275 is about 0.020 inches, allowing the flexible sealing gasket 275 to flex as the lid 200 presses the liner 130 to the ring 120. In another aspect, an angle 287 between the flexible sealing gasket 275 and the underside of the lid flange 285 can be about 30 degrees.

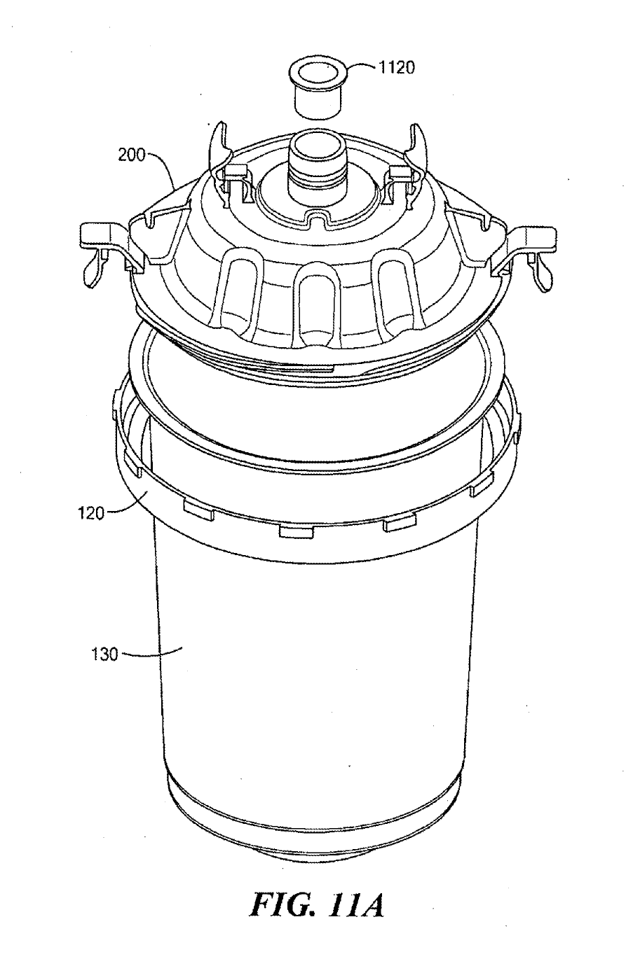

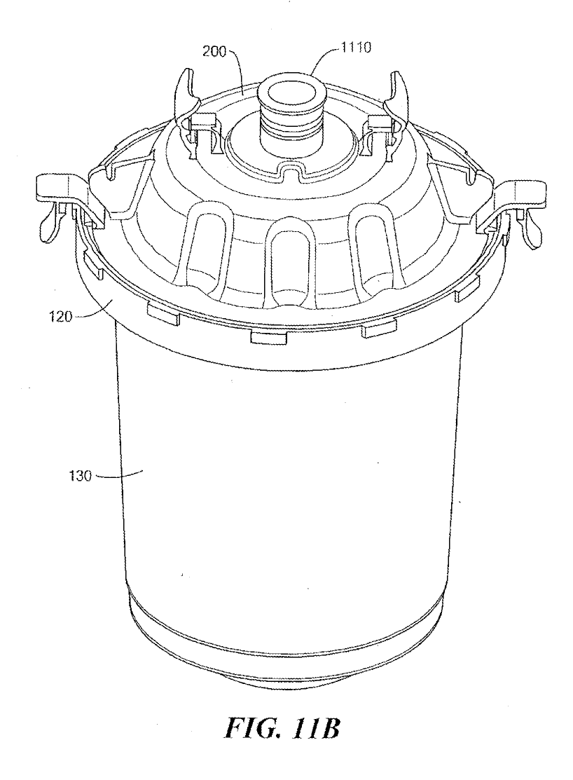

As illustrated in FIG. 11A and FIG. 11B, the unitized ring-lid-liner combination may be manipulated as a liquid-tight unit, e.g., inserted into and removed from the outer cup 110. FIG. 11A includes an exploded view of the combination, while FIG. 11B includes an assembled view of the combination. When the combination of FIG. 11B is removed from the cup 110, the liquid outlet 230 in the lid may be closed with a removable cap or stopper 1110.

With the combination of structure depicted in FIG. 11A and FIG. 11B, used paint can be stored and saved without the outer cup 110. Since a paint shop may have numerous stored paint containers, storing the used paint without the outer cup 110 can provide considerable cost savings. Similarly, paint can be mixed and store temporarily without the outer cup 110 for later use. Further, in disposing of a container with liquid remaining therein, the unitized system can substantially minimizes the risk of the lid 200 separating from the liner 130 as the unit is lifted from the outer cup 110 or as it is tossed, or otherwise placed, into a disposal can. Further, the risk of fire can be substantially minimized, when the liquid is flammable.

Referring now to FIGS. 13-16, an alternative embodiment of a lid is illustrated and generally designated 1200. The lid 1200 is similar to the lid 200 described above in form and function, and can replace the lid 200 in the liquid container system 100 described above. For clarity of description, elements common to both lids 200, 1200 are identified with the same reference numeral.

Referring particularly to FIG. 13 and FIG. 14, the lid 1200 can include two or more modified interlocking tab assemblies 1210 that can be used for retaining the adaptor 240 on the liquid outlet 230 of the lid 1200. Each interlocking tab assembly 1210 can include a clamping tab 1220 for engaging the adaptor ledge 243 of the adaptor 240 and a locking tab 1240, which serves to lock the clamping tab 1220 into the clamping position.

As illustrated, both the clamping tab 1220 and the locking tab 1240 can project upward from the upper surface of the lid 1200. Each clamping tab 1220 can be disposed between the locking tab 1240 and the liquid outlet 230. Each clamping tab 1220 can include an inner arm 1224 that protrudes inwardly toward the liquid outlet 230, and an outer arm 1226 that can protrude outwardly toward the locking tab 1240. Each clamping tab 1220 can also include an upper end 1228 that can extend above the arms 1224, 1226 and that can be manually grasped to manipulate the interlocking tab assembly 1210. Further, each locking tab 1240 can include an inwardly protruding shelf 1244. Above the shelf 1244, each locking tab 1240 can include an upper end 1248 that can bend outward, away from the liquid outlet 230.

In the illustrated embodiment, two interlocking assemblies 1210 are shown. The interlocking tab assembly 1210 shown on the left in FIGS. 13 and 14 is in an interlocked configuration, and the interlocking tab assembly 1210 shown on the right is in a non-interlocked configuration. When in a non-interlocked configuration, the clamping tab 1220 and the locking tab 1240 may not be engaged with each other, and the upper end 1228 of the clamping tab 1220 can be biased to bend outward toward the locking tab 1240. In this configuration, the inner and outer arms 1224, 1226 can be oriented generally vertically, whereby sufficient clearance can be provided between the interlocking tab assembly 1210 and the liquid outlet 230 to permit the adaptor 240 to be assembled on the liquid outlet 230.

When in the interlocked configuration, the clamping tab 1220 can be urged inward toward the liquid outlet 230 until the upper end 1128 is generally vertical, and the inner and outer arms 1224 and 1226 extend generally horizontally. In this configuration, the inner arm 1224 can press on the adapter ledge 243 and clamp the adaptor 240 to the liquid outlet 230. At the same time, the outer arm 1226 can engage the locking tab 1240, whereby the clamping tab 1220 can be locked in this position. In particular, the outer arm 1226 can engage the shelf 1244 and can be maintained in this position by the tendency of the clamping tab 1220 to elastically return to an outwardly biased configuration. Accordingly, the adaptor 240 can be securely fastened to the lid 1200, facilitating use of the spray gun and liquid container system 100 in various orientations.

Referring also to FIGS. 15 and 16, the lid 1200 can includes a secondary flange 1285 that can be formed on the periphery of the lid 1200 at a location above the flange 285. The secondary flange 1285 can be spaced apart from the flange 285, and an upper surface of the secondary flange 1285 can be aligned with the top of the ring 120. The secondary flange 1285 can protrude outward from the periphery of the lid 1200 to the extent that it abuts an inner surface of the ring 120, whereby any paint that was spilled onto the ring 120 during filing of the cup 110 can be maintained within the ring 120 and paint drips are substantially minimized.

Referring to FIGS. 17-19, in another embodiment, a disposable liner 2600 is provided for use in a liquid container system, such as, for example the container system 100 shown in FIG. 1. The liner 2600 can include a non-flat closed end 2610 and an open end 2630 for introducing liquid into the liner 2600. A longitudinal axis 2605 of the liner 2600 can extend between the closed end 2610 and open end 2630. The liner 2600 can be made from any nonporous material, including but not limited to, polyethylene, polypropylene or a flexible film. In certain embodiments, the liner sidewalls can be thicker than the liner bottom, facilitating storage of liquid in the liner.

The liner 2600 can include a V-shaped stiffening rib 2620 that can extend longitudinally from a liner mid portion 2615 on one side of the liner 2600, along the curve that defines the liner closed end 2610, and to the liner mid portion 2615 on the opposed side of the liner 2600. The rib 2620 can extend generally along a longitudinal direction of the liner. Further, the rib 2620 can define a rib angle relative to a longitudinal axis that can be within a range of about 0 degrees to about 10 degrees. In another aspect, the rib angle can be within a range of about 0 degrees to about 5 degrees. Further, rib angle can be within a range of about 0 degrees to about 3 degrees.

In a particular aspect, the liner 2600 can include an average sidewall thickness and the rib 2620 can include a rib thickness that is at least about 20% greater than the sidewall thickness. In another aspect, the rib thickness is at least about 30% greater than the sidewall thickness, such as least about 40% greater than the sidewall thickness, or at least about 50% greater than the sidewall thickness.

In another aspect, the liner 2600 can have an overall diameter. A width of the rib 2620 can be at least about 2% of the overall diameter. Moreover, the width of the rib 2620 can be at least about 3% of the overall diameter, such as at least about 4% of the overall diameter, at least about 5% of the overall diameter, or at least about 6% of the overall diameter. In another aspect, the width of the rib 2620 can be no greater than about 10% of the overall diameter.

In another aspect, the liner 2600 includes a height and the rib 2620 extends along at least about 20% of the height. Further, the rib 2620 can extend along at least about 25% of the height, such as at least about 30% of the height, at least about 40% of the height, or at least about 50% of the height. In another aspect, the rib 2620 does not extend greater than about 75% of the height.

The rib 2620 can generally bisect the liner and extend across the apex of the liner closed end 2610. The rib 2620 can to provide added strength and rigidity to the liner 2600. In particular, the rib 2620 can provide sufficient stiffness to prevent the liner 2600 from bending or slumping to one side, or the other, when the liner 2600 is used in a unitized ring-lid-liner combination without the outer cup 110, and in particular, when placed in an inverted spraying orientation. As such, the rib 2620 can prevent a portion of the liner 2600, e.g., adjacent to and along the rib 2620, from collapsing. Moreover, the rib 2620 can maintain the liner 2600 in a substantially upright position during use.

In particular, the rib 2600 can permit the liner sidewalls on each side of the rib 2620 to collapse inward while the rib 2620 retains the liner 2600 in a generally axially elongated and upright configuration. The rib 2600 can be configured to allow the liner sidewall to collapse inward toward the rib 2600 during use. Moreover, the rib 2600 can be configured to allow the liner sidewall to collapse radially inward before collapsing in a longitudinal direction. Further, the rib 2600 can be configured to promote radial collapse of the liner sidewall while substantially preventing longitudinal collapse of the liner sidewall.

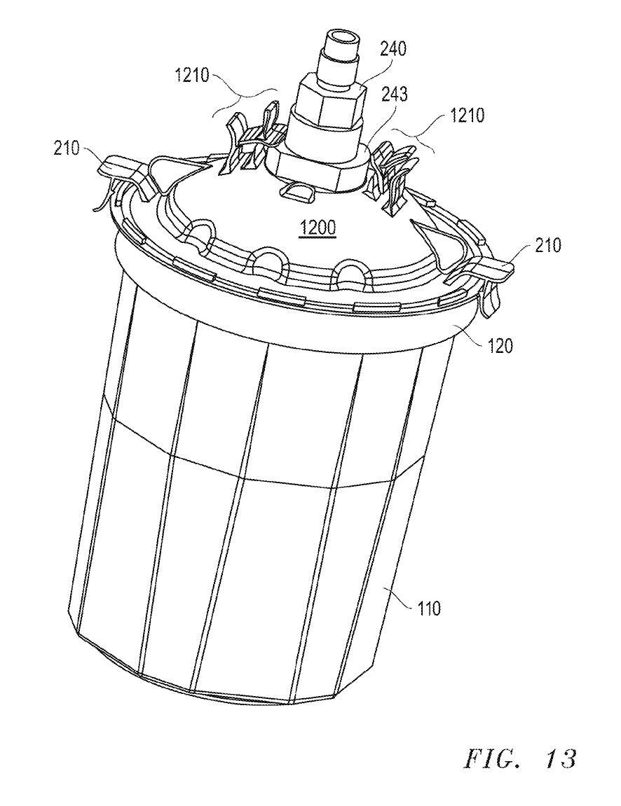

For example, with reference to FIG. 18, the liner 2600 can be configured to collapse in a first direction, X, that is transverse to the longitudinal axis 2605, while remaining in an uncollapsed configuration (i.e., not collapsing) in a second direction transverse to both the first direction and the longitudinal axis 2605 (i.e., a direction perpendicular to the page). In other words, the rib 2620 can provide a biasing force that can substantially prevent the liner 2600 from collapsing in a direction along a line passing from one side of the rib 2620 to the other side of the rib or along a plane passing through the entire rib 2620 (i.e., both sides thereof).

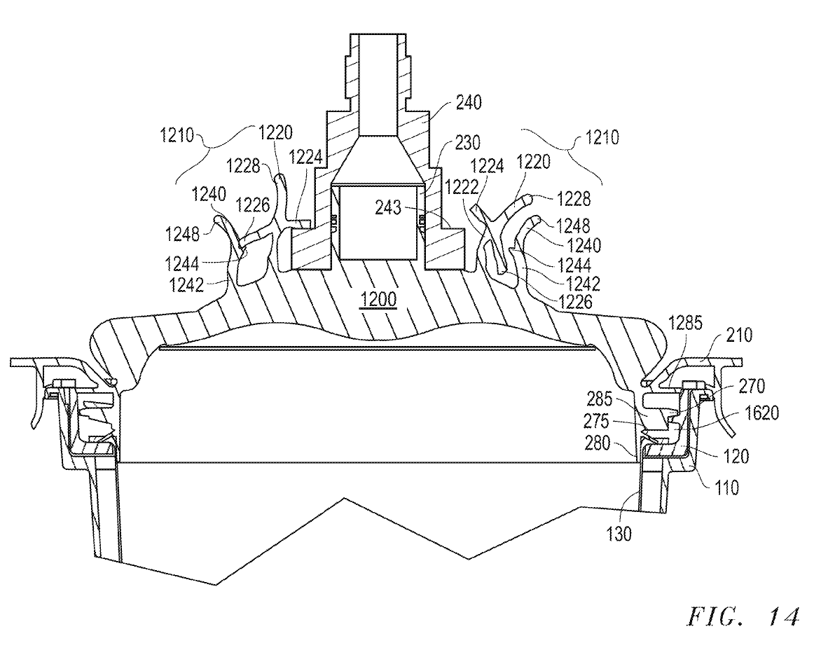

Referring to FIG. 19, the rib 2620 can be formed by providing a triangular fold in the liner material. In a particular embodiment, the fold angle, θ, is about 44 degrees, and each fold side can have a length, B1, of about 0.100 inches such that the rib 2620 can protrude outward from the outer surface of the liner 2600 at a distance, B2, of about 0.072 inches or less. However, the rib 2620 may not be limited to this configuration. For example, the fold angle, θ, can be in a range of, and including, about 30 degrees to about 60 degrees. Further, the fold side length, B1, may be in the range of about 0.050 inches to about 0.300 inches.

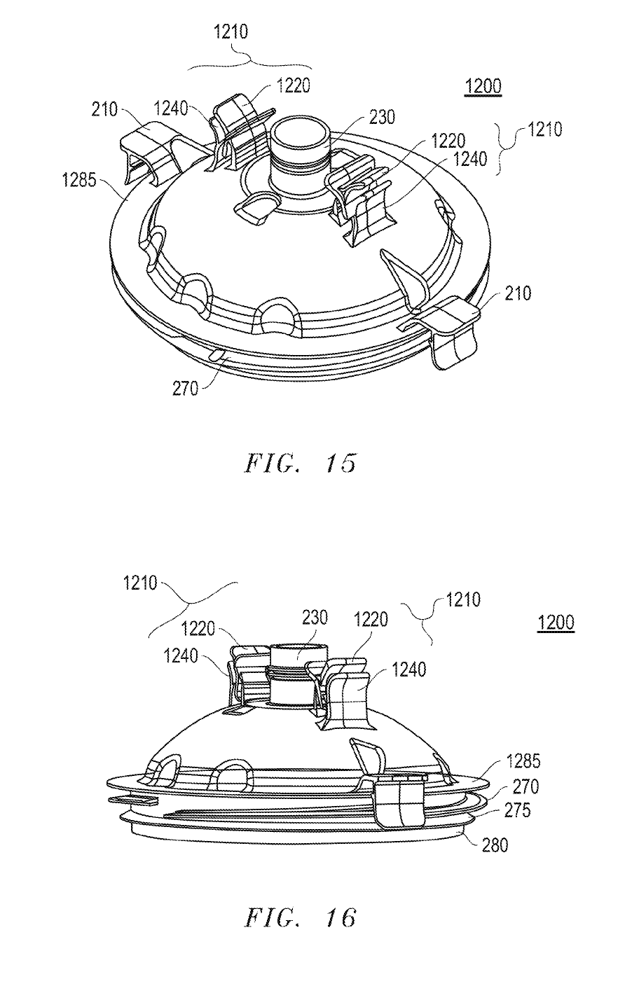

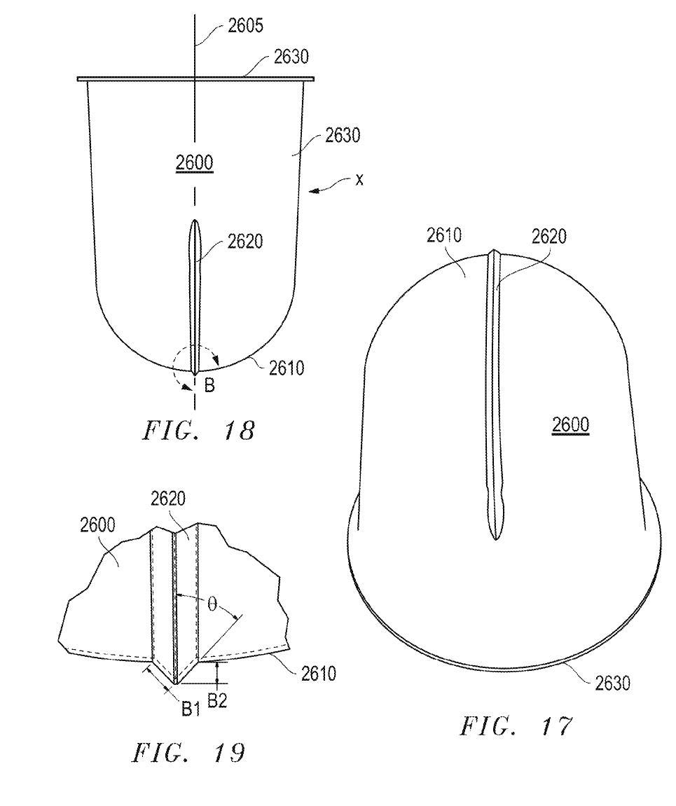

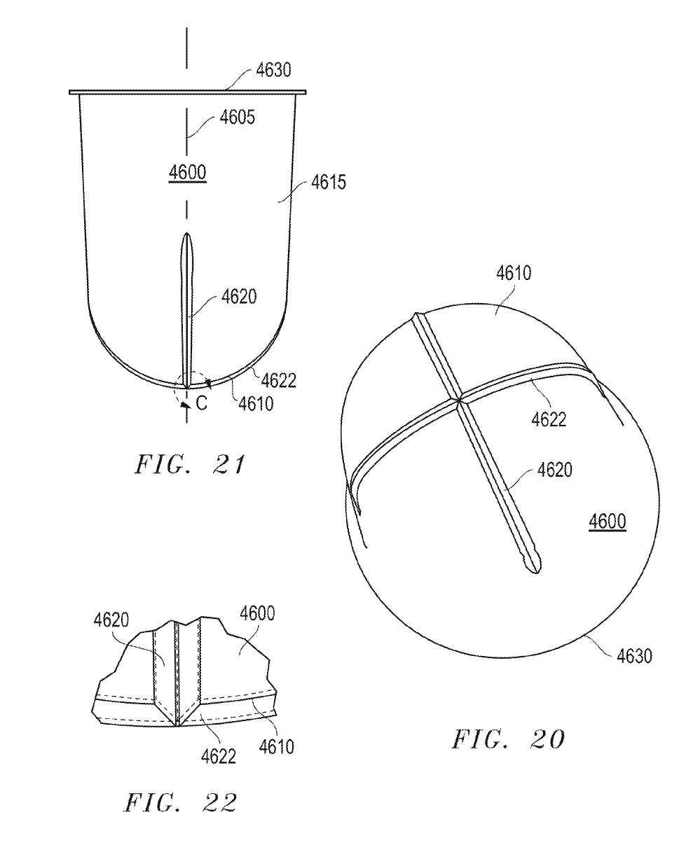

Referring to FIG. 20 through FIG. 22, the liner 2600 may not be limited to a single stiffening rib 2620. In an alternative embodiment, the liner 4600 can include two V-shaped stiffening ribs 4620, 4622. The liner 4600, like the liner 2600, can be used in a liquid container system, such as, for example the container system 100 shown in FIG. 1. As illustrated, the liner 4600 can include a non-flat closed end 4610, an open end 4630 for introducing liquid into the liner 4600, and a longitudinal axis 4605 that can extend between the closed end 4610 and open end 4630.

Each stiffening rib 4620, 4622 can extend longitudinally from a liner mid portion 4615 on one side of the liner 4600, along the curve that defines the liner closed end 4610, and to the liner mid portion 4615 on the opposed side of the liner 4600. Each rib 4620, 4622 can generally bisect the liner and extend across the apex of the liner closed end 4610. The two ribs 4620, 4622 can intersect and specifically, the two ribs 4620, 4622 can be arranged so as to orthogonally intersect at the apex of the liner 4600.

In another aspect, the ribs 4620, 4622 can establish an intersection angle of at least about 60 degrees. Further, the intersection angle can be at least about 65 degrees, such as at least about 70 degrees, at least about 75 degrees, at least about 80 degrees, at least about 85 degrees, or at least about 90 degrees.

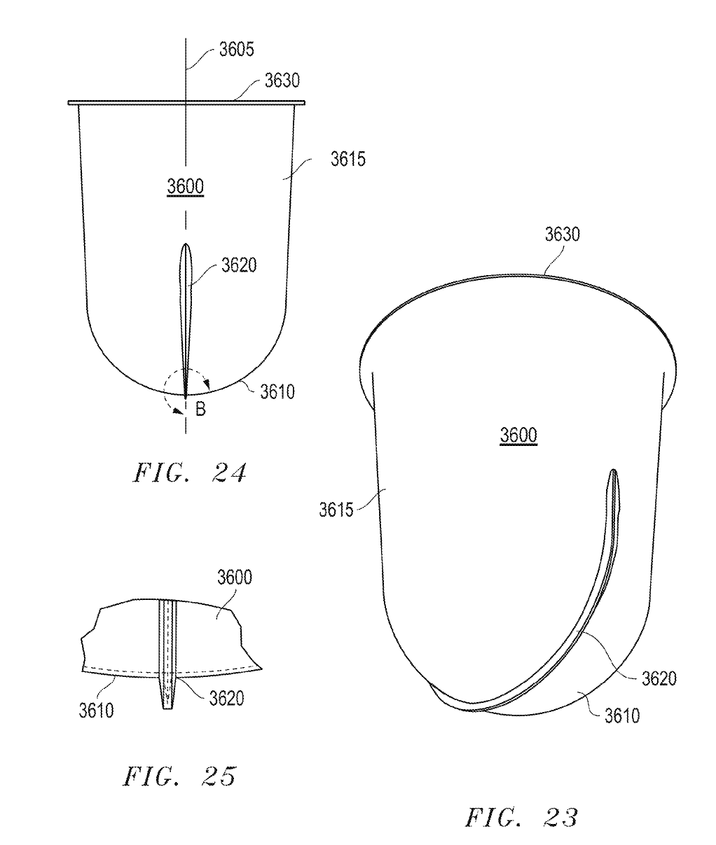

Referring to FIG. 23 through FIG. 25, another embodiment of disposable liner 3600 is provided for use in a liquid container system, such as, for example the container system 100 shown in FIG. 1. The liner 3600 can include a non-flat closed end 3610, an open end 3630 for introducing liquid into the liner 4600, and a longitudinal axis 3605 that can extend between the closed end 3610 and open end 3630.

The liner 3600 can include a coined V-shaped stiffening rib 3620 in which the sides of the V can be can be “coined” or pressed together and sealed via heat or ultrasound to further strengthen the rib 3620. Accordingly, a coined stiffening rib 3620 can have a thickness that is about twice as thick as the liner 3600 adjacent to the coined stiffening rib 3620. The rib 3620 can extend longitudinally from a liner mid portion 3615 on one side of the liner 3600, along the curve that defines the liner closed end 3610, and to the liner mid portion 3615 on the opposed side of the liner 3600. The rib 3620 can generally bisect the liner and extend across the apex of the liner bottom 3620. In a particular aspect, the rib 3620 can provide added strength and rigidity to the liner 3600.

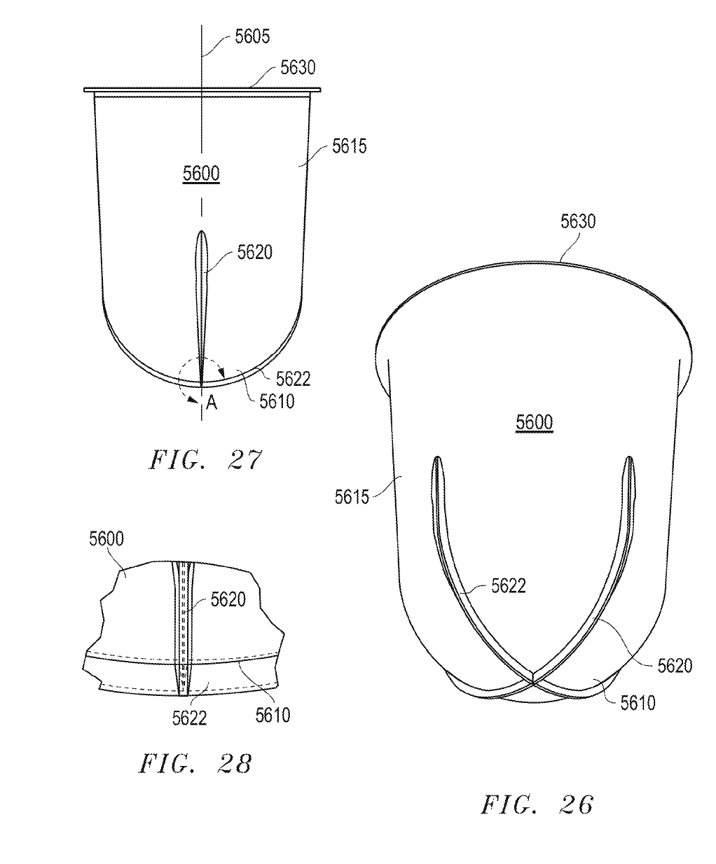

Referring to FIG. 26 through FIG. 28, the liner 3600 may not be limited to a single coined stiffening rib 3620. In an alternative embodiment, a liner 5600 that can include two V-shaped stiffening ribs 5620, 5622 is illustrated. The liner 5600 can be used in a liquid container system, such as, for example the container system 100 depicted in FIG. 1. The liner 5600 can include a non-flat closed end 5610, an open end 5630 for introducing liquid into the liner 5600, and a longitudinal axis 5605 that can extend between the closed end 5610 and open end 5630.

Each stiffening rib 5620, 5622 can extend longitudinally from a liner mid portion 5615 on one side of the liner 5600, along the curve that defines the liner closed end 5610, and to the liner mid portion 5615 on the opposed side of the liner 5600. Each rib 5620, 5622 can generally bisect the liner 5600 and extend across the apex of the liner bottom 5610. The two ribs 5620, 5622 can intersect each other and can be arranged so as to orthogonally intersect at the apex of the liner 5600.

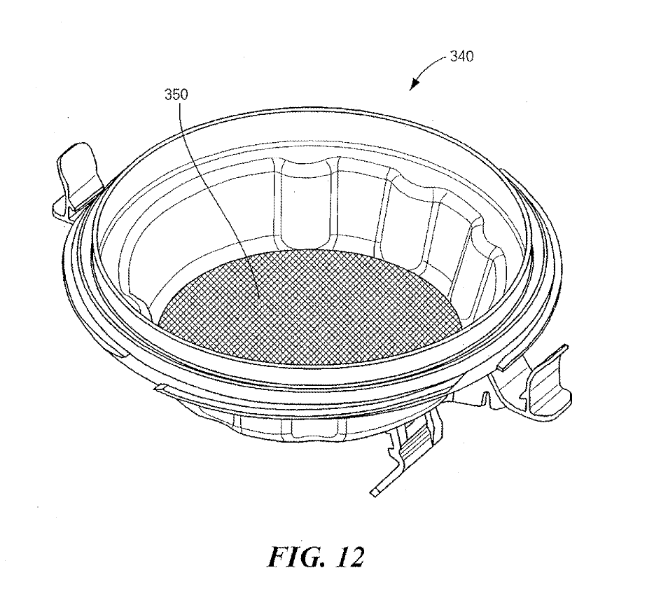

In certain embodiments, a filter can be provided for any of the liquid container systems described above. The filter, which can be removable, can filter the liquid withdrawn from the liquid container system. In a particular embodiment, a filter 350 can be built into the underside of the lid 340 in the container assembly, as shown in FIG. 12. Liquid withdrawn from the liquid container system through the lid outlet can be filtered as the liquid passes through the filter.

In a particular aspect, a paint spraying system is disclosed and can include a spray gun having a nozzle and a liner can be in fluid communication with the spray gun. The liner can provide paint to the spray gun. Further, the liner can include a non-planar closed end, an open end opposed to the closed end, a liner sidewall extending between the closed end and the open end, and a first rib extending at least partially along the liner sidewall.

Further, a method for spraying paint can include filling a liner with paint and fluidly coupling the liner with a paint sprayer so that the liner provides paint to the sprayer. The method can also include expelling paint from the paint sprayer and as the paint is expelled from sprayer, the liner can collapse in at least one radial direction while remaining substantially non-collapsed in a longitudinal direction perpendicular to the at least one radial direction. The method can also include inverting the spray gun and liner. The liner can remain substantially upright while paint is expelled from the spray gun.

It will, of course, be apparent that the present disclosure is not limited to the aspects of the description set forth above. Various changes and modifications to the embodiments described herein will be apparent to those skilled in the art without departing from the spirit and scope of those embodiments.

1. A liner for use with a liquid container system for a spray gun, the liner including:
a non-flat closed end;
an open end opposed to the closed end;
a liner sidewall extending between the closed end and the open end; and
a first rib extending at least partially along the liner sidewall.

2. The liner of claim 1, wherein the first rib extends generally along a longitudinal direction of the liner.

3. The liner of claim 1, wherein the rib angle a rib angle relative to a longitudinal axis within a range of about 0 degrees to about 10 degrees.

4.-5. (canceled)

6. The liner of claim 1, wherein first rib extends across the closed end of the liner.

7.-8. (canceled)

9. The liner of claim 1, wherein the first rib comprises a stiffening member extending from the liner sidewall.

10. The liner of claim 9, wherein the stiffening member includes a fold in the liner sidewall having a triangular cross-section having a first fold side and second fold side separated by a fold angle.

11.-12. (canceled)

13. The liner of claim 9, wherein the stiffening member comprises a coined V shape.

14.-15. (canceled)

16. The liner of claim 1, wherein the liner includes a sidewall thickness and the first rib includes a rib thickness that is at least about 20% greater than the sidewall thickness.

17.-19. (canceled)

20. The liner of claim 1, wherein the liner has an overall diameter and a width of the first rib is at least about 2% of the overall diameter.

21.-25. (canceled)

26. The liner of claim 1, wherein the liner includes a height and the first rib extends along at least about 20% of the height.

27.-31. (canceled)

32. The liner of claim 1, further comprising a second rib extending along the liner sidewall.

33. The liner of claim 32, wherein the second rib comprises a rib selected from the following group: a triangular rib, a V-shaped rib, and a coined V shaped rib.

34.-35. (canceled)

36. The liner of claim 32, wherein the second rib intersects the first rib.

37.-44. (canceled)

45. The liner of claim 36, wherein the second rib intersects the first rib at about an apex of the closed end of the liner.

46.-49. (canceled)

50. The liner of claim 1, wherein the first rib is configured to prevent a portion of the liner sidewall from collapsing during use.

51.-53. (canceled)

54. The liner of claim 1, wherein the first rib is configured to allow the liner to collapse radially inward before collapsing in a longitudinal direction.

55. The liner of claim 1, wherein the first rib is configured to promote radial collapse of the liner while substantially preventing longitudinal collapse of the liner.

56.-57. (canceled)

58. A paint spraying system, comprising:
a spray gun having a nozzle;
a liner in fluid communication with the spray gun, the liner providing paint to the spray gun, wherein the liner comprises a non-planar closed end, an open end opposed to the closed end, a liner sidewall extending between the closed end and the open end, and a first rib extending at least partially along the liner sidewall.

59. A method for spraying paint, the method comprising:
filling a liner with paint;
fluidly coupling the liner with a paint sprayer, wherein the liner provides paint to the sprayer;
expelling paint from the paint sprayer, wherein as the paint is expelled from sprayer, the liner collapses in at least one radial direction while remaining substantially non-collapsed in a longitudinal direction perpendicular to the at least one radial direction.

60. The method of claim 59, further comprising:
inverting the spray gun and liner, wherein the liner remains substantially upright while paint is expelled from the spray gun.
